(19) United States
(12) Patent Application Publication
(10) Pub. No.: US 2006/0291760 A1
(43) Pub. Date: Dec. 28, 2006

(54) Roller bearing with a sealing element

(75) Inventor: Herbert Voit, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/471,344

(22) Filed: Jun. 20, 2006

(30) Foreign Application Priority Data
Jun. 25, 2005 (EP) 05 013 740.5

(51) Int. Cl. F16C 33/76

(52) U.S. Cl. 384/484

(57) ABSTRACT

A roller bearing includes a radially outer bearing ring and a radially inner bearing ring. A ring-shaped holding space is formed between the bearing rings where a sealing element is mounted. The sealing element has a fastening section which is fixed to the outer bearing ring, and a lip section with two sealing lips which rest against and slide on the inner bearing ring to establish a sealing connection between the lip section and the inner bearing ring.

### BACKGROUND OF THE INVENTION

1. Field of the Invention

The invention pertains to a roller bearing with a sealing element in a ring-shaped holding space between an outer bearing ring and an inner bearing ring.

2. Description of the Related Art

Roller bearings are well known in general. For example, as release bearings, they represent a primary component of the release mechanism which actuates dry friction clutches in motor vehicles. The duty conditions of this type of release bearing in the power train of a motor vehicle require that, to obtain the longest possible service life, the interior space of the bearing, in which the rolling elements are in force-transmitting, rolling contact with the races of the bearing, must be carefully sealed. The standard practice is to provide sealing elements, which are intended to minimize the escape of lubricant from the bearing and to prevent the intrusion of dirt into the bearing.

Roller bearing seals in motor vehicles which are exposed to extremely large amounts of dust and dirt, such as those used in the mining industry, for example, must fulfill especially strict requirements. The foreign particles, which are suspended, for example, in the ambient air, easily enter the transmission bell and are transported there by the circulating air directly to the clutch-release system, where, along with the material abraded from the clutch, which is always present in any case, they settle primarily on the sealing elements of the release bearing. As a result of the axial loads on the release bearing, which pulsate because of the way in which the mechanism operates, and as a result of the wear-promoting aggressiveness of the suspended matter or dust particles, the efficiency of the sealing system gradually decreases. This leads to the premature failure of the sealing system, and failure of the sealing system leads ultimately to failure of the release bearing and thus to failure of the entire friction clutch.

A roller bearing with a sealing element is disclosed in DE 197 09 056 A1. Here, the sealing element has a flange, which rests permanently on the outer ring of the roller bearing. The sealing element has two spreading, inverted V-shaped sealing lips, which establish a sealing connection with the inner ring. The sealing lip located further inward on the bearing is a component of a contact seal and is in sliding contact with a conical sealing surface, whereas the sealing lip in the outer position on the bearing cooperates with a cylindrical surface adjacent to the previously mentioned conical surface to form a sealing gap for a labyrinth seal.

U.S. Pat. No. 6,561,337 discloses another roller bearing. The sealing element of this roller bearing also has two sealing lips in the form of a contact sealing lip and a labyrinth sealing lip. The sealing element thus forms an outer labyrinth seal and an inner contact seal on a ring of a roller bearing. In contrast to the previously mentioned sealing element, the two sealing lips assigned to the roller bearing ring cooperate with a common cylindrical surface on the ring. The diameter of the contact sealing lip is slightly smaller than that of the inner ring of the bearing, whereas the diameter of the labyrinth sealing lip is slightly larger than that of the inner ring. When the sealing element is installed, an elastic radial arm section on the base body of the seal allows the contact sealing lip to pivot, so that it can rest under pretension against the sealing surface of the bearing ring. However the labyrinth sealing lip does not pivot, and does not contact the sealing surface.

The sealing elements described above with an outward-directed labyrinth seal and an inward-directed contact seal provide a roller bearing with only limited protection, because, during use, especially the small particles (dust particles) are able to pass around the labyrinth seal and can then accumulate directly on the contact sealing lip. As a result of vibrations, these collections of particles become more tightly compacted and can finally destroy the contact sealing lip by abrasion and thus ultimately penetrate into the interior of the bearing. The bearing suffers increased wear and fails sooner than it would have otherwise.

### SUMMARY OF THE INVENTION

Proceeding from this background, it is an object of the present invention to provide a roller bearing with a sealing element which protects the roller bearing more effectively against foreign particles, especially dust particles, and which also ensures a long service life of the roller bearing even under extremely harsh conditions. The sealing element is also intended to be compact in design and capable of being installed easily and reliably on the roller bearing.

According to a preferred embodiment of the invention, a roller bearing with a sealing element is thus proposed, where the sealing element is mounted on the roller bearing in a ring-shaped holding space between a radially outer and a radially inner bearing ring and is held in place initially on the outer bearing ring by means of a fastening section. The sealing element has a lip section with two sealing lips by which it establishes a sealing connection with the inner bearing ring. Both sealing lips of the sealing element rest against and slide on the inner bearing ring.

In this way, an additional, i.e., second, barrier is created for relatively small particles and moisture. This barrier makes it much more difficult for dirt to enter the interior of the roller bearing and can also withstand the destructive effects of such dirt particles for a longer period of time. Thus, the present invention makes it possible to achieve a significant increase in the service life of a roller bearing. At the same time, an operationally reliable roller bearing is provided for working environments exposed to large amounts of dust.

It is advantageous for the sealing lips to rest on the roller bearing axially spaced apart a predetermined distance so as to form an axially outer and an axially inner sealing lip.

It has also been found advisable for the sealing lips to extend radially from a base area of the sealing element and to diverge axially as they extend radially from the base area toward the inner bearing ring.

It is especially advantageous for the base area to have a pivot center, around which the sealing lips can pivot elastically in common during installation, so that, after installation, each lip will rest with a defined amount of pretension against its assigned sealing surface.

In order to effectively initiate the pivoting movement required for this process, it is advantageous that, before the sealing element is installed, the diameter of one of the sealing lips is smaller than that of the sealing surface of the inner bearing ring, and the diameter of the other sealing lip is larger than that of the sealing surface.

If the lip section cooperates with the inner bearing ring of the roller bearing, the axially inner sealing lip will have a smaller diameter and the axially outer sealing lip a larger diameter than the sealing surface of the inner bearing ring before the installation of the sealing element.

According to an especially advantageous embodiment of the invention, the sealing element is installed on the inner bearing ring by means of a relative axial movement between the sealing element and the bearing ring, where the outer sealing lip is guided so that initially it is a certain radial distance away from the sealing surface, and where the subsequent contact of the inner sealing lip with the inner bearing ring causes the axially inner lip to be deflected radially outward, as a result of which the axially outer sealing lip is also deflected inward and brought into contact with the sealing surface. This means that the pivoting movement by which the sealing lips are brought into their final positions is initiated and controlled by the contact of the inner sealing lip with the edge of one of the components of the roller bearing. This reliably prevents the outer sealing lip from becoming turned in the wrong direction.

It is also advantageous for the two sealing lips to rest on a common sealing surface of the inner bearing ring. As a result, additional surfaces and machining steps are rendered unnecessary. A cylindrical surface on the inner bearing ring is suitable as a common sealing surface, and such a surface is also especially easy to produce.

For the sake of stiffening, the sealing element includes a reinforced section with a stiffening element, such as a stiffening ring.

A simple and operationally reliable means of mounting the fastening section on the outer bearing ring is to provide a snap-in lip on the sealing element. This lip can then can be snapped into a circumferential ring-shaped groove in the outer bearing ring.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial cross section of a roller bearing;

FIG. 2 shows a partial cross section of a sealing element with two contact lips; and

FIGS. 3a-c show the sequence of steps by which the sealing element of FIG. 2 is mounted on the roller bearing according to FIG. 1.

### DETAILED DESCRIPTION OF THE PRESENTLY PREFERRED EMBODIMENTS

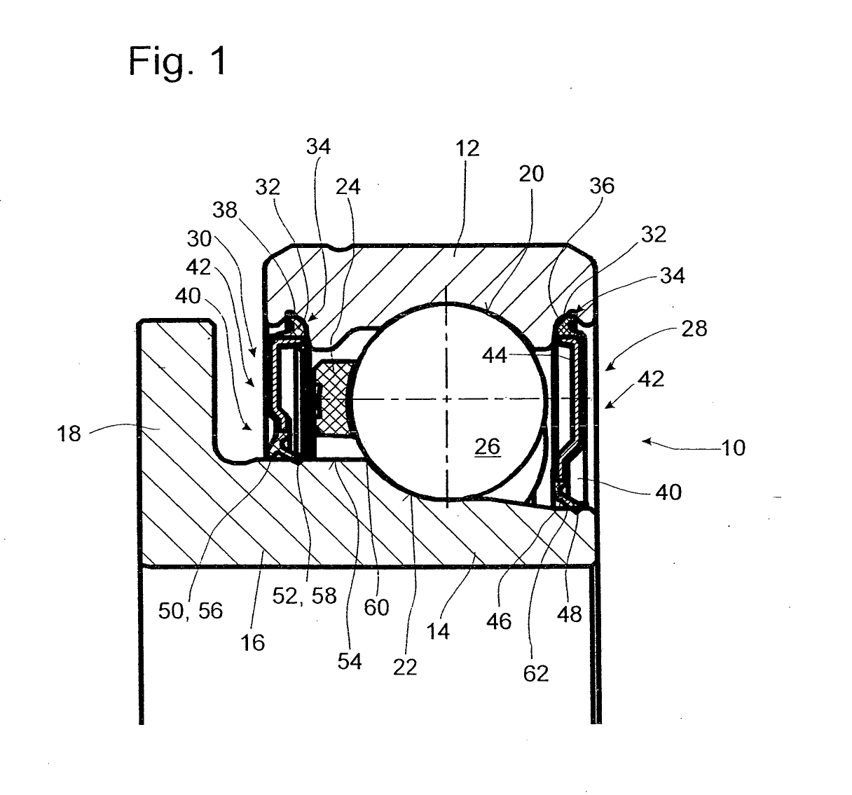

FIG. 1 shows a partial cross section of a release bearing 10, which is a component of a release device for actuating a motor vehicle friction clutch. The roller bearing 10 is designed as an angular contact ball bearing and has a first, radially outer bearing ring 12, which is stationary, and a second, radially inner bearing ring 14, which rotates. The inner bearing ring 14 has an axial extension 16, which extends out beyond the outer bearing ring 12. The extension 16 carries a flange 18, which is designed to act on a release element (not shown) of the friction clutch to transmit the actuating force.

The bearing rings 12, 14 have facing races 20, 22 for balls 26 which are guided in a ball cage 24. To prevent the intrusion of dirt and also to prevent the escape of lubricant present in the interior of the roller bearing 10, two contact sealing elements 28, 30, made of an elastic material, are installed in a ring-shaped holding space between the bearing rings 12, 14. The contact sealing elements 28, 30 have different inside diameters, and each has a snap-in lip 32 on a fastening section 34, by which the contact sealing element 28, 30 is held in place in a circumferential ring-shaped groove 36, 38 in the outer bearing ring 12, whereas the radially inner lip section 40 rests against the inner, rotating bearing ring 14 to form a sealing connection. A reinforcing section 42 is provided in each case between the fastening section 34 and the inner lip section 40. Here the elastic base body of the sealing elements 28, 30 is reinforced by a metal stiffening ring 44, which is bent inward at the roller bearing 10 in the area of the fastening section 34, whereas it has a cranked section in the transition area to the inner lip section 40.

The first sealing element 28 is provided as a contact seal with a single, outward-directed sealing lip 46, a sealing edge 48 of which rests in sliding contact against the inner bearing ring 14 of the roller bearing 10 and therefore prevents the escape of lubricant from the roller bearing 10 and the intrusion of dirt into the interior of the roller bearing 10.

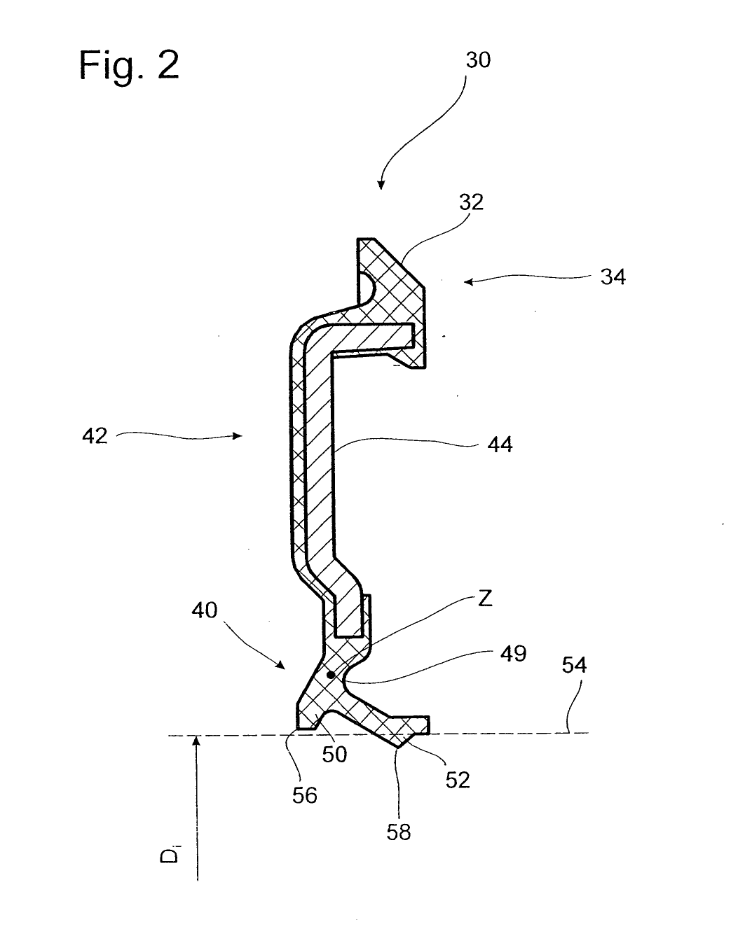

Referring also to FIG. 2, the second sealing element 30 has the same design as the first sealing element 28 except for the formation of the inner lip section 40. In contrast to the first sealing element 28, the lip section 40 of the second sealing element 30 comprises a base area 49, from which two sealing lips 50, 52 proceed in the shape of a “V”, thus spreading apart as they extend toward the inner bearing ring 14. After the sealing element 30 has been installed, the sealing edges 56, 58 on the sealing lips 50, 52 rest in sliding contact against the inner bearing ring 14. The outer sealing lip 50 in the axially outer position with respect to the roller bearing 10 functions as a dust lip, and the inner sealing lip 52 functions primarily as a grease lip.

As can be seen in FIG. 2, before the sealing element 30 is installed, the inner sealing lip 52 has a smaller diameter and the outer sealing lip 50 a larger diameter than the diameter Dᵢ of the sealing surface 54, indicated here by a dotted line, of the radially inner bearing ring 14. The outer sealing lip 50 is thus shorter than the inner sealing lip 52.

In addition, the inner sealing lip 52 of the sealing element 30 and the single sealing lip 46 of the sealing element 28 point in the direction facing away from the flange 18.

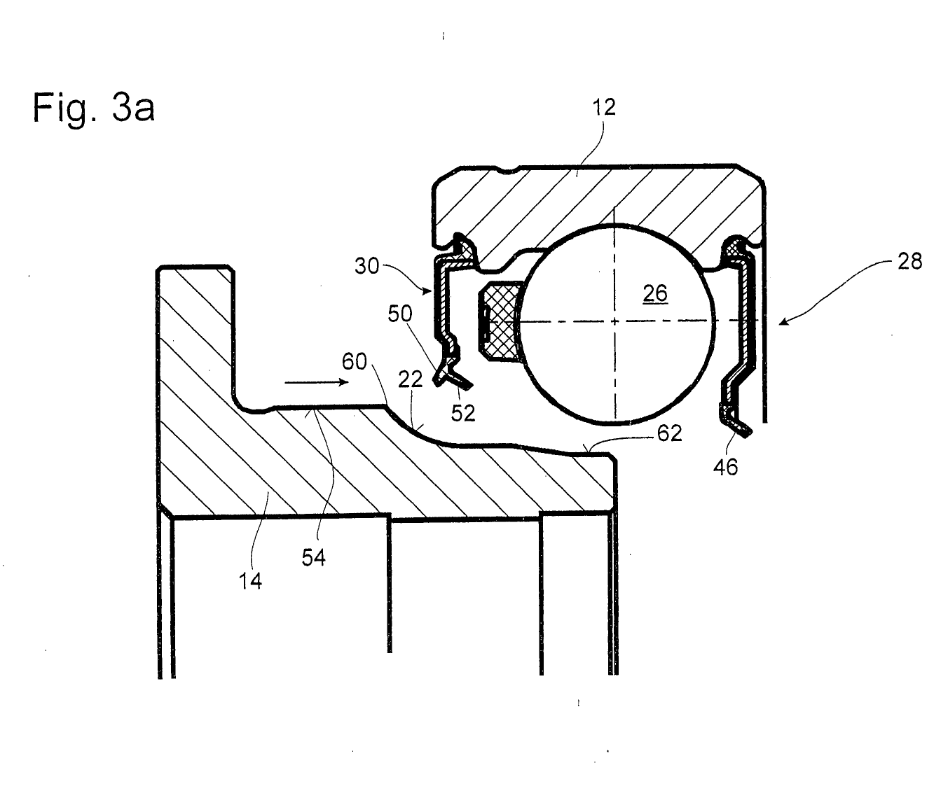

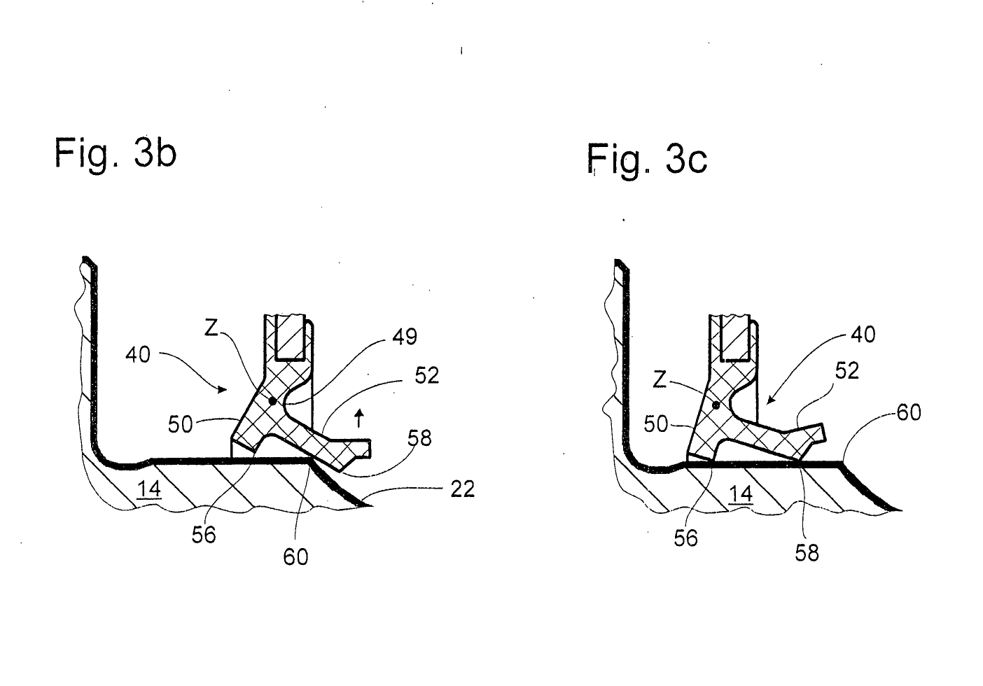

When the roller bearing 10 is being assembled, the snap-in lips 32 of the two sealing elements 28, 30 are first snapped into the grooves 36, 38 in the outer bearing ring 12, and the ball cage 24 containing the balls 26 is positioned on this ring (FIG. 3a). Then, by means of a relative axial movement, the inner bearing ring 14 is moved toward this preassembled unit in such a way that the outer sealing lip 50 of the sealing element 30 remains initially a certain radial distance away from the sealing surface 54. This movement is continued until the inner sealing lip 52 touches the edge 60 formed between the race 22 and the sealing surface 54 (FIGS. 3b, 3c), whereupon, during the further course of assembly, the inner sealing lip 52 is deflected in a radially outward direction, indicated by the arrow in FIG. 3b. The common base area 49 of the sealing lips 50, 52 is designed with a cross section which is tapered with respect to the immediately adjacent areas, as a result of which a pivot center Z is produced for the common elastic pivoting of both sealing lips 50, 52. The result is that the radial deflection of the sealing lip 52 also causes the outer sealing lip 50 to pivot radially inward. Thus the outer sealing lip 50 is also brought into contact with the sealing surface 54. During the further course of the assembly process, the sealing edge 48 of the sealing lip 46 of the sealing element 28 also arrives in the desired contact position with a sealing surface 62 provided on an axial end of the inner bearing ring 14.

Of course, the roller bearing 10 can also be designed so that the fastening sections 34 of the sealing elements 28, 30 rest on the inner bearing ring 14 and the sealing lips 46 or 50, 52 rest with a sealing action on the outer bearing ring 12. The sealing lips 50, 52, furthermore, do not have to rest on one and the same sealing surface 54 on the roller bearing 10 but can instead rest on different surfaces.

The invention is not limited by the embodiments described above which are presented as examples only but can be modified in various ways within the scope of protection defined by the appended patent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A roller bearing comprising:
a radially outer bearing ring and a radially inner bearing ring forming a ring-shaped holding space therebetween; and
a sealing element having a fastening section fixed to said outer bearing ring and a lip section in contact with said inner bearing ring, said lip section comprising a pair of sealing lips which rest and slide on said inner bearing ring.

2. The roller bearing of claim 1 wherein said sealing lips are spaced apart axially.

3. The roller bearing of claim 1 wherein said lip section comprises a base area, said sealing lips diverging axially as they extend radially from said base area toward said inner bearing ring.

4. The roller bearing of claim 3 wherein said base area has a pivot center, around which both of said sealing lips pivot elastically during installation.

5. The roller bearing of claim 2 wherein said inner bearing ring comprises a sealing surface against which both said sealing lips rest in common.

6. The roller bearing of claim 5 wherein said sealing surface has a predetermined diameter, and said sealing lips also have predetermined diameters, and wherein, before said sealing element is installed, said diameter of one of said sealing lips is smaller than said diameter of said sealing surface of said inner bearing ring, whereas said diameter of said other sealing lip is larger than said diameter of said sealing surface.

7. The roller bearing of claim 6, wherein, before said sealing element is installed, said diameter of said axially inner sealing lip is smaller than said diameter of said sealing surface of said inner bearing ring, whereas said diameter of said axially outer sealing lip is larger than said diameter of said sealing surface.

8. The roller bearing of claim 5 wherein said sealing surface is a cylindrical surface.

9. The roller bearing of claim 1 wherein said sealing element has a reinforced section with a stiffening element.

10. The roller bearing of claim 1 wherein said fastening section has a snap-in lip, and said outer bearing ring has a circumferential ring-shaped groove, said snap-in lip fitting into said groove.

11. Method of assembling a roller bearing comprising a radially outer bearing ring and a radially inner bearing ring forming a ring-shaped holding space therebetween, and a sealing element having a fastening section fixed to said outer bearing ring and a lip section comprising a pair of sealing lips to be contacted with said inner bearing ring, the method comprising the steps of:
moving said sealing element axially toward said radially inner bearing ring so that an axially outer sealing lip is a predetermined radial distance away from a sealing surface of said inner bearing ring; and
subsequently moving said sealing element axially toward said radially inner bearing ring so that an axially inner sealing lip contacts said radially inner bearing ring and is deflected radially outward and, as a result, said axially outer sealing lip is deflected radially inward to establish a contact between both said sealing lips and said sealing surface.
